(19) United States
(12) Patent Application Publication
(10) Pub. No.: US 2016/0154127 A1
(43) Pub. Date: Jun. 2, 2016

(54) METHOD OF SEISMIC SIGNAL SOURCE PLACEMENT FOR SEISMIC ACQUISITION SYSTEM

(71) Applicant: SCHLUMBERGER TECHNOLOGY CORPORATION, Sugar Land, TX (US)

(72) Inventors: Aleksei Shevchenko, Moscow (RU); Vasily Baydin, Chelyabinsk (RU); Ilya Seleznev, Moscow (RU)

(21) Appl. No.: 14/953,248

(22) Filed: Nov. 27, 2015

(30) Foreign Application Priority Data
Nov. 27, 2014 (RU) 2014147815

(51) Int. Cl. G01V 1/28; G06F 17/10

(52) U.S. Cl. CPC G01V 1/282; G06F 17/10

(57) ABSTRACT

A standard acquisition system is selected, the system comprising seismic signal sources disposed on an excitation surface and seismic signal receivers disposed on an acquisition surface, and specifying a fold number. A bin size is selected for a reflecting boundary, and the reflecting boundary is broken down into bins with the selected size. Ray tracing from each seismic signal receiver to each bin at the reflecting boundary and elongating of a reflected ray from the reflecting boundary to the acquisition surface are performed by computer simulation. A density of the seismic sources at the excitation surface is calculated using a computer program. Then, based on the calculated seismic signal source density, the seismic sources are disposed at the excitation surface for the selected seismic acquisition system providing the specified fold number.

### CROSS-REFERENCE TO RELATED APPLICATION

This application claims priority to Russian Application No. 2014147815 filed Nov. 27, 2014, which is incorporated herein by reference in its entirety.

### BACKGROUND

The invention relates to geophysics, in particular, to methods of seismic exploration.

Seismic exploration uses artificially induced elastic waves to identify boundaries of rock formations with different elastic properties. Seismic exploration is used for finding oil and natural gas fields, as well as for conducting various investigations of underground strata. The most widespread method of seismic exploration is the reflection method. Currently, this method is used for exploration of deposits of oil, gas and other minerals. In the reflection method, a seismic wave excited by explosion or mechanical impact propagates from a seismic signal source and travels through several reflecting boundaries in the earth crust, i.e. boundary surfaces of the rocks. A reflected wave is generated at each boundary, which travels back to the location where receivers are installed. Historically, source location is called an excitation surface, and receiver location is called an acquisition surface. It is also possible to use the terms “an excitation region” and “a reception region”; one has to keep in mind that excitation and acquisition can be carried out near the Earth or sea surface. In downhole seismic acquisition, excitation and reception regions are represented as excitation and reception lines.

Source and receiver locations can be different, depending on seismic acquisition conditions. For example, for onshore seismic acquisition, where seismic signals are emitted from shallow wells drilled 5-10 m from surface, seismic receivers are placed directly on surface, which in this case acts as an acquisition surface. For offshore seismic acquisition, where signal sources are submerged 5-10 m below sea surface, seismic receivers are also submerged under the sea surface, often at greater depths than the signal sources. In this case, acquisition surface is at some depth below the sea surface. For seismic acquisition in wells, sources are normally placed on the Earth surface or lowered in shallow wells, while the receivers are run into deep wells for registering seismic fields at a depth (rather than on surface). Location of seismic receiver in a well will be the acquisition surface in this case. Sometimes seismic sources can be disposed in a well, while receivers are placed on the Earth surface or also in wells.

Recording of seismic signals traveling from one source at the shotpoint (SP) is provided by multiple receivers or a receiver array, which are installed at different distances from SP. Using multiple receivers for recording seismic signals depends on the acquisition technology and economic factors, as it involves recording from multiple locations during a minimum time and at a minimum cost. Relative position of the seismic receivers and seismic signals sources (or SP) is called an acquisition system.

When planning locations of seismic receivers and seismic sources in the investigated area, several different factors should be taken into consideration, such as geological objective, anticipated quality seismic acquisition (i.e. seismic exploration), availability of equipment and whether the equipment can be installed on acquisition surface or in wells, economic factor and time factor. To optimize the acquisition system from the point of view of geological objectives, seismic sources and seismic receivers should be placed so that the investigated reflecting boundaries would be displayed (illuminated) and their spatial position could be determined with as little error as possible.

In order to reduce ambiguity of identifying geological features, acquisition systems are used with redundant seismic sources and receivers, placed at a high density (Urupov A. K., Fundamentals of 3D seismic: Manual for higher education institutions.—Moscow: FSUE Oil and Gas Publishing House, 2004, p. 27-70).

Evaluation of a proposed acquisition system includes determining sizes of a reflecting element of the investigated object, called bin. Bin is an elementary fragment of the planned acquisition system. One bin corresponds to one trace obtained as a result of seismic image data processing. For 2D acquisition systems, a bin is a linear section located along the seismic receiver line. Normally, bin size is 10, 20, 25 or 30 m, depending on quality specifications of a seismic survey. For 3D acquisition systems, bin is normally a rectangle. Normally, bin size is 20×20 m, 25×20 m, or other depending on acquisition configuration. Acquisition systems can be irregular, with different bin sizes and shapes. But from the point of view of seismic acquisition horizontal resolution, bin size defines minimum dimensions of geological features identified in seismic survey with the selected acquisition system and bin size.

The second important parameter of a seismic acquisition configuration is a fold number. The fold number is defined as a number of various rays reflected from a fragment of boundary whose size is equal to one bin. Existing methods of acquisition system optimization solve two tasks: increasing of the fold number and maintaining a uniform spatial distribution of deletions in bins. When planning a borehole acquisition system, increasing of the fold number is usually achieved by increasing a number of shotpoints and optimal location of shotpoints on the Earth surface. Therefore, approaches to planning seismic surveys are mostly focused on the selection of an optimum step between the SP locations, i.e. distances between the seismic signal sources (Urupov A. K. Fundamentals of 3D seismic: Manual for higher education institutions.—Moscow: FSUE Oil and Gas Publishing House, 2004, p. 46-52).

Traditional approaches to planning acquisition systems in seismic exploration are based on rigid selection of acquisition parameters to provide sufficient redundancy of the acquisition systems. These core acquisition parameters are a fold number and a bin size. It is believed that redundant acquisition density allows operators to avoid errors during the actual shooting. Normally, the parameters which can be varied during acquisition system planning are minimum and maximum distances between sources and receivers. To calculate the fold number and other parameters, a flat-boundary medium model can be used. It is rather a substantial simplification, which often leads to incorrect solutions. Using conventional approaches with multiple model runs, it is very difficult and time-consuming to find optimum locations of seismic sources on the excitation surface.

### SUMMARY

The proposed method provides for an improved quality of seismic survey with a required fold number by uniform illumination of target objects, saving costs of conducting field work because no repeated acquisitions are required.

According to the proposed method, a standard acquisition system is selected, the system comprises seismic signal sources disposed on an excitation surface and seismic signal receivers disposed on an acquisition surface, and a fold number is specified. A bin size is selected for a reflecting boundary, and the reflecting boundary is broken down into bins with the selected size. Ray tracing from each seismic signal receiver to each bin at the reflecting boundary and elongating of a reflected ray from the reflecting boundary to the acquisition surface are performed by computer simulation. A density of the seismic sources at the excitation surface is calculated using a computer program. Then, based on the calculated seismic signal source density, the seismic sources are disposed at the excitation surface for the selected seismic acquisition system providing the specified fold number.

### BRIEF DESCRIPTION OF DRAWINGS

The invention is explained by the drawings.

FIG. 1 shows a fragment of reflecting boundary with three bins;

FIG. 2 shows a fragment of a connection matrix corresponding to the rays and the bins shown on FIG. 1;

FIG. 3 shows seismic signal source positions for a spiral acquisition system;

FIG. 4 shows seismic signal receiver positions in a borehole for a spiral acquisition system;

FIG. 5 shows a source density map for a spiral acquisition system;

FIG. 6 shows a fold number density map at the reflecting boundary;

FIG. 7 shows a calculated optimal source density and positions of the sources for a spiral acquisition system;

FIG. 8 shows a calculated optimal fold number obtained by optimization of a 3D VSP.

### DETAILED DESCRIPTION

The method involves a ray-path computer simulation and calculating seismic signal source positions using a computer program based on known information about a geological object being studied (a reflecting boundary).

According to an embodiment of the invention, a standard acquisition system is selected, the system comprising a specified number of seismic signal sources and receivers disposed at some spacing (allowable for seismic equipment) in a borehole, on Earth or sea surface. For offshore seismic surveys, the sources can be installed in a spiral pattern; for onshore seismic surveys a system of seismic lines is used.

Then a required fold number is specified and a bin size is selected for a reflecting boundary. The bin size can be within certain limits, depending on frequency bank of the excited seismic signal and position of the geological object. The bin size is selected according to the size of first Fresnel zone (R_{F}), calculated for a given model of the medium for the simplest acquisition system using common formulas (e.g., Zavalishin B. R. On sizes of boundary fragment generating reflected wave. Applied geophysics. Nedra, 1975, p. 77, or Goertz A., Milligan P., Karrenbach M., Paulsson B. Houston: Optimized 3D VSP survey geometry based on Fresnel zone estimates, SEG Annual Meeting, 2005. p. 2641-2645. VSP 2.5).

Seismic bin size is reflected in the spatial sampling step of the observed data processing results. In this case, the “degree of similarity” or correlation of two adjacent traces on the seismic data mainly depends on the selected bin size. Two seismic signals reflected from the adjacent bins will coincide if the bin size is less than (R_{F}/7), therefore, this value defines a lower limit of the bin size. The bin size larger than (R_{F}/2) is not feasible since the difference in the signals on adjacent tracks can be more than 25% of the total energy. Therefore, the optimal bin size (B) for seismic acquisition planning should be within the range:

$$\frac{{R}_{F}}{7} < B < \frac{{R}_{F}}{2}$$

No criteria is defined for selecting bin size within this range: such criteria may be economic constraints or constraints associated with duration of seismic survey.

Thus, the following apriori information should be used for implementing the proposed method:

a velocity model of the medium with the selected reflecting boundary. The velocity model and the reflecting boundary are specified approximately since there is very little information about the object before observation. Therefore, as a rule, the model of the medium is single-layer with a flat or curvilinear reflecting boundary and a constant layer velocity. But if the medium model is known from previous seismic surveys, a more complicated model can be used in this case. If such model is used, the proposed method does not change, except the ray tracing procedure becomes more costly from the point of view of calculation time and the required computer power;

a bin size specified for the reflecting boundary;

a specified number of seismic sources and receivers placed in a borehole or on the Earth or sea surface, at a certain distance from each other (allowable for the seismic equipment); and

the required fold number.

Then the reflecting boundary, for which an acquisition system needs to be calculated, is broken down into bins of the specified size.

A computer simulation (see, for example, Alekseyev A. S., Gelchinsky B. Ya. On ray-path method of calculating wavefields in heterogeneous media with curvilinear interface boundaries. In book: Issues of dynamic theory of wave propagation. Issue III, Leningrad, Leningrad State University Publishing House, p. 107-160) is used for ray tracing from the seismic sources to each bin on the reflecting boundary and the reflected beams are continued to the specified acquisition surface. Ray tracing is understood to be any algorithm which is used for connecting two points in the space of a velocity model. It is unimportant what spatial properties are used. For example, a medium can be isotropic or anisotropic, as well as homogeneous or heterogeneous. What is important, however, is to obtain and use information on ingoing and outgoing angles of the rays in the model.

Each ray is traced to the reflecting boundary, is reflected, and continued to the acquisition surface. Three points are defined for each ray: a starting point of a ray, an exit point of the ray to the acquisition surface and the ray reflection point from the reflecting boundary. Thus, a system of rays is created connecting starting points of the ray with each bin (on the reflecting boundary) and with the surface where ray final points are located.

The resultant ray family is used for calculating optimal seismic source positions on the excitation surface providing the specified fold number distribution.

The surface area with the ray final point positions is been fragmented into blocks similar to the bins on the reflecting boundary. The blocks dimension size dictates the smoothing power of the acquisition system optimization. Minimum recommended surface blocks size is twice bigger than bin size.

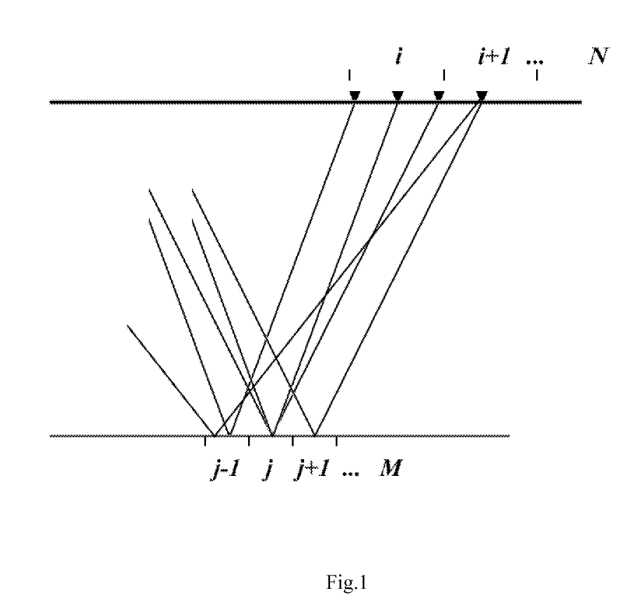

FIG. 1 shows a fragment of the reflecting boundary with three adjacent bins (j−1,j,j+1). FIG. 1 also shows two elements of a grid (i,i+1), in which four sources (SP) are located. The rays connecting the acquisition surface, the reflecting boundary and the source are tied to two grids. It means that each ray has two indices, one is an index of the bin from which the ray has reflected, the other is an index of the grid cell on the surface where the end of this ray is located.

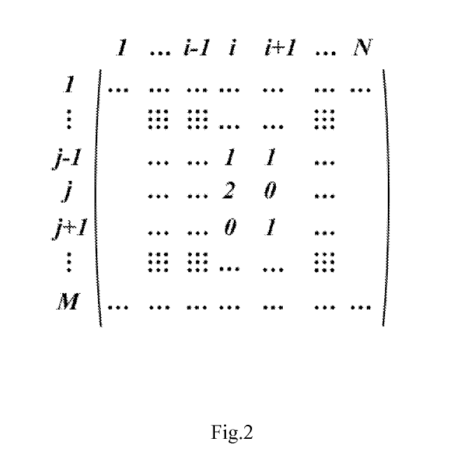

To find an optimal position of the sources on the surface providing the specified fold number d_{f}, we have to find a correlation between the boundary and the Earth surface. The correlation will be defined by a connection matrix C, sizes N×M, where N—a number of grid cells on the Earth surface, and M—a number of bins identified on the reflecting boundary. Elements of the connection matrix Cᵢⱼ=k define fold number k in the bin connection j on the reflecting boundary and zone i on the Earth surface. Number k defines the number of rays reflected from the bin j and coming to the surface within a grid area i. FIG. 2 shows a fragment of connection matrix corresponding to the rays and the bins shown on FIG. 1. To find distribution of sources of the Earth surface dₛ, we will solve the following equation system:

Cᵢⱼdₛ=d_{f}

The specified massif d_{f} can reflect fold number along the profile or specify fold number map for a 3D seismic acquisition system. Similarly, the seismic source density derived from the equation can be either source density along the line, or characterize areal locations of sources on the Earth surface. A solution to the equation system is sought with a limitation to the vector dₛ. All elements of the vector should be positive as they define density of source distribution on the acquisition surface. It means that value d_{Si}, linked to the i-th cell, is equal to the number of rays ending in the given cell. Using calculated density d_{S}, an optimal position of seismic sources (SP) is calculated at the next step.

In this case, the optimal criteria for an acquisition system is the specified fold number at the specified geologic boundary.

At this stage, calculation of seismic source (SP) positions is made for the selected acquisition system and the calculated density d_{S}. Another system can be selected, for example, a spiral system where the sources are placed at different distances from each other. The distances are controlled by a spiral step and a distance between the points located on the spiral. A base map (line scheme) for placement of seismic sources (SP) can be determined in advance.

The problem of distributing the points can be solved using any standard methods, such as direct calculation, trial and error method, or Monte Carlo method.

Additional conditions or additional optimal criteria can be applied when planning the acquisition system, such as:

restrictions on reflection angles or positions of the sources on the acquisition surface;

advantage of certain source and receiver positions over another positions; and

advantage of certain angles and azimuths over another angles and azimuths.

Possibility of introducing additional optimization conditions is an important advantage of the proposed method. Restrictions on ray trajectories are imposed at the ray tracing stage. In this case, the collection of rays on which the connection matrix Cᵢⱼ is created will only contain rays that satisfy the imposed restrictions.

Optimization with the advantage of one ray over another ray is achieved by introducing normalization in the linear equation system. Such method is a standard approach in linear equation system problems (see, for example, Lowson C, Henson R. Numerical solution to the least square method, Moscow, Nauka, 1986, p. 137-152).

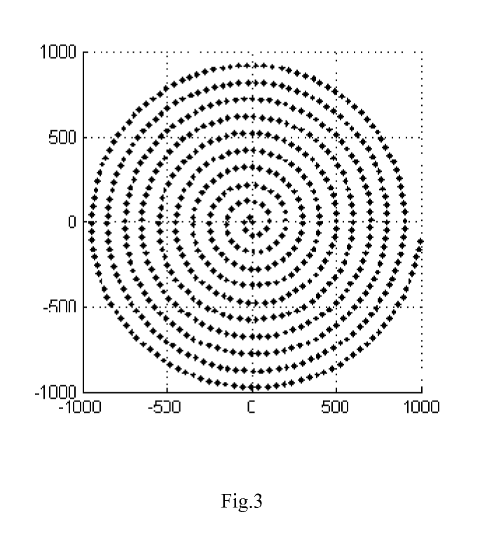

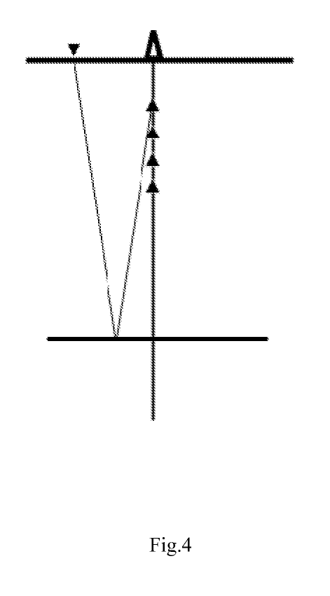

One example of disposing seismic sources for a 3D VSP seismic survey is described. A homogeneous medium with a constant velocity and a horizontal reflecting boundary is selected as an initial model. FIG. 3 shows an example of standard placement of sources for a spiral acquisition system of vertical seismic profiling. In this case, receivers are installed in a well located in the center of the spiral, as shown on FIG. 4. The acquisition system in the well consists of 20 seismic instruments with 15-m spacing. The size of bin used for fold calculation is set to be equal to a step between shotpoints, i.e. 50×50 m. Potential reduction of bin sizes causes a reduced fold number, but in this case the overall distribution pattern in the near-wellbore zone will be preserved.

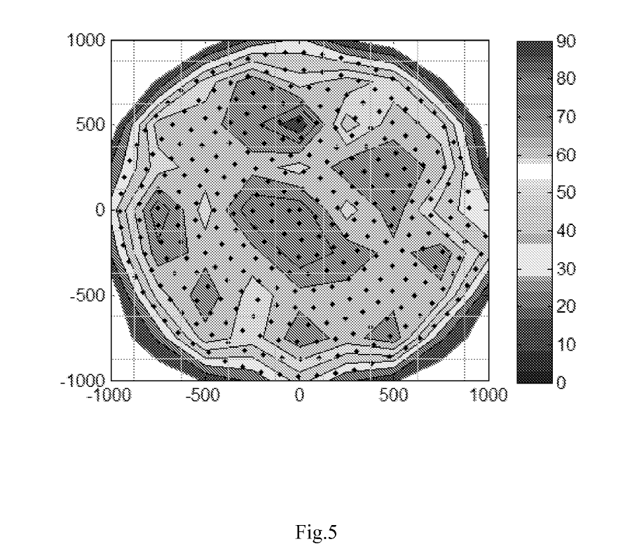

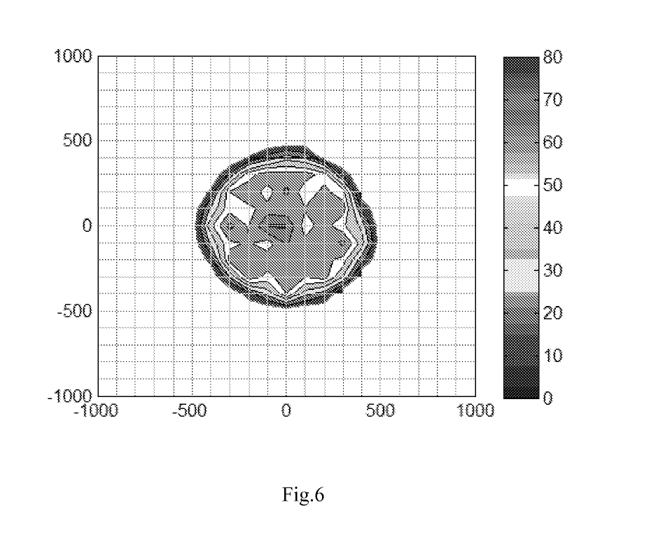

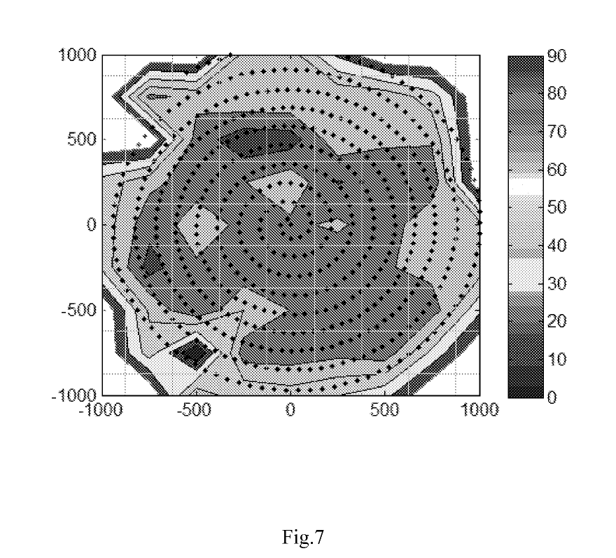

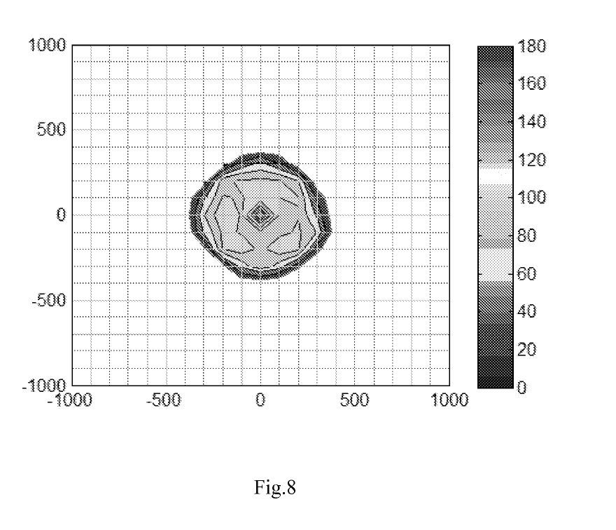

FIG. 5 shows seismic source density on the excitation surface (density is shown in grayscale), source positions are shown as dots. A fold number reflection map (FIG. 6) has been plotted for the selected acquisition system. The resultant fold varies in the near-wellbore zone within the range of 50-70, decreasing to zero at bins located at 400-500-m distance from the well. In order to optimize source positions to achieve the fold number equal 100, we will select a bin of the same size, i.e. 50×50 m. Then we will trace rays from the receiver positions into the bins on the reflecting surface and continue them to the Earth surface. Using the completed ray tracing, we will create a connection matrix and solve an equation system. The calculated density of sources is shown on FIG. 7 in grayscale. Using the resultant density, source positions are restored for the selected spiral configuration. Sources on FIG. 7 are indicated as dots. Based on the selected acquisition system, a fold number map (FIG. 8) is calculated for checking. The fold number is distributed around 100, which was specified as the required fold number when the source positions were calculated for the specified acquisition system.

1. A method for disposing seismic sources for a seismic acquisition system, comprising:
selecting a standard acquisition system comprising seismic signal sources disposed at an excitation surface and seismic signal receivers disposed at an acquisition surface;
specifying a fold number;
selecting a bin size for a seismic reflecting boundary;
breaking the seismic reflecting boundary into bins having the selected bin size;
by a computer simulation carrying out ray tracing from each seismic signal receiver to each bin at the seismic reflecting boundary and continuing a reflected ray from the seismic reflecting boundary to the acquisition surface,
calculating a density of seismic sources at the excitation surface using a computer program, and
based on the calculated seismic source density, disposing the seismic signal sources at the excitation surface for the selected seismic acquisition system providing the specified fold number.

2. The method of claim 1 wherein the acquisition surface is an earth surface.

3. The method of claim 1 wherein the acquisition surface is a sea surface.

4. The method of claim 1 wherein the acquisition surface is disposed in a borehole.

5. The method of claim 2 wherein the standard acquisition system is a system of seismic lines.

6. The method of claim 2 wherein the standard acquisition system is a spiral system.

7. The method of claim 1 wherein during ray tracing additional restrictions are imposed on ray trajectories.

8. The method of claim 6 wherein the additional restrictions are restrictions on reflection angles of the rays from the reflecting boundary.

9. The method of claim 1 wherein the additional restrictions are restrictions on positions of the seismic signal sources on the acquisition surface.

10. The method of claim 1 wherein the additional restrictions are advantages of certain seismic signal source positions over other positions.
